(19) United States
(12) Patent Application Publication
(10) Pub. No.: US 2006/0236148 A1
(43) Pub. Date: Oct. 19, 2006

(54) One hot counter proxy

(76) Inventors: Glenn Wood, Colorado Springs, CO (US); Michael Rytting, Colorado Springs, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/040,556

(22) Filed: Jan. 21, 2005

(51) Int. Cl. G06F 1/14

(52) U.S. Cl. 713/502

(57) ABSTRACT

A method and apparatus for sequencing includes sequencing elements in rippled combination, each sequencing element processing a subset of de-multiplexed incoming data over a single resource cycle. Each sequencing element processes a one hot counter proxy that represents a sequencer counter.

### BACKGROUND

Logic analyzers in use today function by observing multiple channels' incoming digital data and performing a data storage function based upon bit patterns identified in the incoming data. The intelligence of the logic analyzer lies in its sequencer, which observes the incoming data signals, and produces signaling based upon the incoming data patterns. The signaling is typically a set of output signals that direct other areas of the logic analyzer to perform functions. A user is able to designate those functions performed and what input patterns cause the designated functions to be performed. The sequencer of the logic analyzer is a programmable state machine that makes decisions based upon patterns in the incoming data. One method of implementing a state machine is to provide a look up table (herein “LUT”). As such, the LUT accepts a current state of the sequencer and the incoming data as inputs that provides output indicating a new state of the sequencer and signaling destined to initiate performance of designated functions. Ideally, the sequencer operates at the speed of the incoming data. As data speeds and number of channels increase, however, it becomes more difficult to provide a sequencer fast enough to accommodate the incoming data.

One method for addressing the data speed challenge is to de-multiplex the incoming data to a more manageable speed for the LUT. For each de-multiplex factor, however, memory requirements to implement the sequencer increase geometrically and the solution quickly becomes prohibitively costly. Additionally, it takes more time to process de-multiplexed data through the sequencer and at some point, the benefits gained through de-multiplexing are lost due to increased processing time. Another method is to cascade the LUTs to reduce the memory requirements. Disadvantageously, however, each LUT and interconnecting logic must still operate at the speed of the incoming data. Incoming digital data speeds are currently at 2 GHz and increasing. Using current technology, cascaded LUTs are not able to operate at that speed.

There is a need, therefore, to provide a sequencer that can operate at speed for incoming digital data with an opportunity for improved speeds as technology progresses.

### BRIEF DESCRIPTION OF THE DRAWINGS

An understanding of the present teachings can be gained from the following detailed description, taken in conjunction with the accompanying drawings of which:

FIG. 1 is a block diagram of a logic analyzer.

FIG. 2 is a circuit diagram of a sequencer according to the present teachings.

FIG. 3 is a circuit diagram of sequencing element according to the present teachings.

FIG. 4 is a flow chart of a process according to the present teachings.

FIGS. 5 and 6 illustrate another embodiment of a sequencer and sequencing element respectively according to the present teachings.

FIGS. 7, 8, and 9 illustrate another embodiment of a sequencer and sequencing element according to the present teachings.

FIGS. 10 through 15 illustrate another embodiment of a sequencer and sequencing element according to the present teachings.

FIG. 16 is a flow chart of an embodiment of a process according to the present teachings.

### DETAILED DESCRIPTION

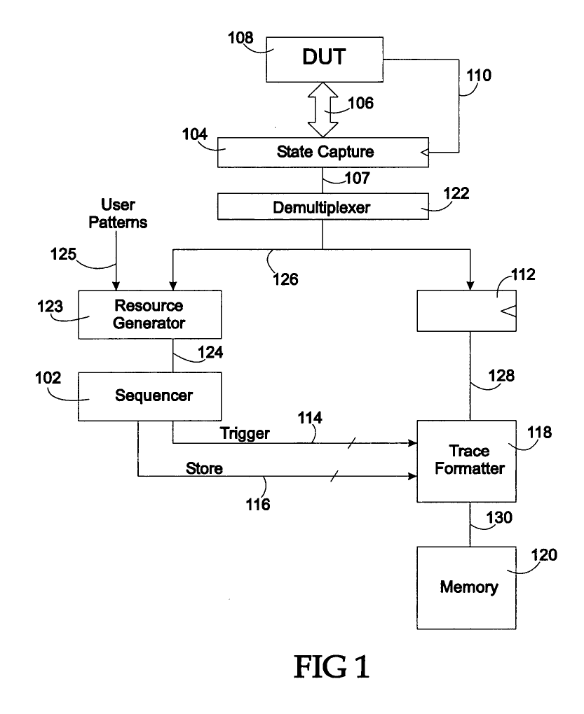

With specific reference to FIG. 1 there is shown basic building blocks of a logic analyzer including sequencer 102 according to the teachings of the present invention. The logic analyzer accepts incoming digital data 106 from DUT 108, which is latched into state capture register 104 by DUT clock 110. De-multiplexer 122 accepts capture register output 107 and de-multiplexes it 8 to 1 for simultaneous presentation of the de-multiplexed data 126 to resource generator 123 and latency matching register 112. The resource generator 123 accepts the de-multiplexed data 126 and compares it against patterns 125 established by a user. Results of the pattern matches within the resource generator 123 generate resources 124. Because the resources 124 are de-multiplexed, further data processing is able to proceed at a slower speed than the incoming data rate. The sequencer 102 accepts the resources 124, and generates one or more control signals 114, 116 for data storage. The control signals 114, 116 from the sequencer 102, referred to as trigger 114 and store 116, are connected to trace formatter 118. The trace formatter 118 accepts an output 128 of the latency matching register 112 and selectively stores one or more cycles of the incoming digital data patterns 130 in memory 120 for eventual presentation to a logic analyzer user. In a specific embodiment, the trigger control signal 114 anchors the logic analyzer measurement in time. The store control signal 116 controls whether any one cycle of digital data is stored in the memory 120.

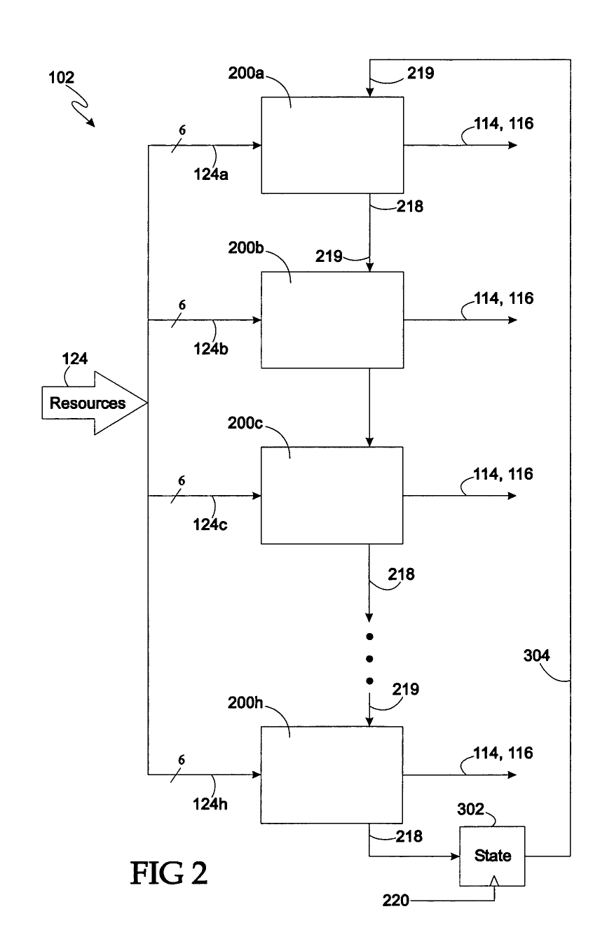

With specific reference to FIG. 2 of the drawings, there is shown a first embodiment of a sequencer 102 according to the present teachings comprising a plurality of sequencing elements 200. In a specific embodiment, the de-multiplexer 122 de-multiplexes the output of the state capture register 104 8 to 1. Other embodiments may have a different de-multiplexing multiple. Because of the 8 to 1 multiplexing in the specific embodiment, there is one resource cycle for every 8 cycles of incoming data 106. In the specific embodiment that uses the 8 to 1 de-multiplexing, there are eight sequencing elements 200a through 200h, where one sequencing element processes each data cycle. The sequencing elements 200 are connected in a parallel rippled combination interconnected by actual next state 218 and actual previous state 219 signals. The actual next state output 218 from a first one of the sequencing elements 200a becomes the actual previous state input 219 of a second one of the sequencing elements 200b. All sequencing elements 200 are similarly interconnected. The actual next state 218 of the 8^{th} sequencing element 200h is latched into state latch 302. State latch output 304 is connected to the actual previous state input 219 of the 1^{st} sequencing element 200a. Accordingly, the actual next state 218 of a last one of the sequencing elements 200h informs the first one of the sequencing elements 200a in a next resource cycle. The sequencing elements 200, therefore, have 8 cycles of the incoming data to properly process a current resource cycle before receiving a next resource cycle. Each sequencing element 200 generates the store and trigger control signals 114, 116 for presentation to the trace formatter 118. The data path through the latency matching register 112 and trace formatter 118 is similarly de-multiplexed and proceeds in parallel with processing that proceeds in the sequencer 102. From a timing perspective, the control signals 114, 116 from the first sequencing element 200b relate to control of the first cycle of every 8 cycles of the incoming data 106, control signals 114, 116 from the second sequencing element 200b relate to control of the second cycle of every 8 cycles of the incoming data 106, and the control signals 114, 116 from the eighth sequencing element 200h relate to control of the last cycle of every 8 cycles of the incoming data 106. In a specific embodiment, therefore, there are 8 store control signals 114 and 8 trigger control signals 116 that are received by the trace formatter 118.

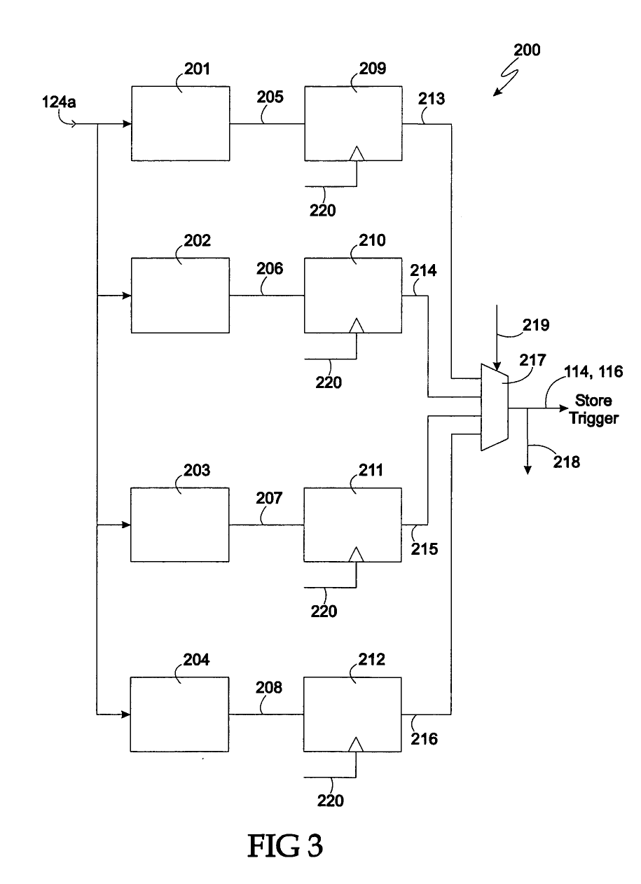

With specific reference to FIG. 3 of the drawings, there is shown an embodiment of the first sequencing element 200a according to the present teachings in which there are four memories that function as respective first, second, third and fourth look up tables 201-204, respectively. Each look up table 201-204 is configured to determine a next possible state 205-208 for each one of four possible previous states based upon its inputs 124a. The first look up table 201 determines the next possible state 205 based upon the inputs 124a assuming the previous actual state is state0, the second look up table 202 determines the next possible state 206 based upon the same inputs 124a assuming the previous actual state is state1, the third look up table 203 determines the next possible state 207 based upon the same inputs 124a assuming the previous actual state is state2, and the fourth look up table 204 determines the next possible state 208 based upon the same inputs 124a assuming the previous actual state is state3. The illustrative example discusses a 4-state state machine. Alternative embodiments of the sequencing element for a state machine with more than four states may have additional look up tables to accommodate the additional states. Each look up table 201-204 accepts as its input 124a, a subset of the resources 124. As the resources subset 124a is presented to the look up tables 201-204, the respective possible next states 205-208 are presented at the output of the look up tables 201-204. Because the sequencer of the present teachings is a state machine, an actual next state is based upon the incoming data 106 as well as an actual previous state. The multiple next state determinations provide a conditional next state for all previous state possibilities and at the look up table processing stage, are independent of the actual previous state 219. The possible next states 205-208 are latched into first, second, third, and fourth sequencer registers 209-212. The sequencing element clocking signal 220 for the first through fourth sequencing registers 209-212 comprises a derivative of the DUT clock 110. In the embodiment with 8 to 1 de-multiplexing, the clocking signal 220 is synchronized with and is ⅛^{th} the frequency of the DUT clock 110. An output 213-216 of each sequencer register 209-212 reflects each one of the next possible states 205-208 and is presented to sequencer multiplexer 217. The sequencer multiplexer 217, with all possible next states available to it, selects an actual next state 218 among the next possible states 205-208 based upon an actual previous state 219. Advantageously, determination of the possible next states 205-208 is able to occur before or in parallel with the determination of the actual previous state 219. Final determination of the actual next state 218, therefore, is a matter of multiplexer selection, which is a faster process than the look up table operation. The output of the look up tables 205-208 also include values for the trigger 114 and store 116 control signals relative to the subset of resources 124a being processed. Each sequencing element 200 in FIG. 2 has the structure of the sequencing element shown in FIG. 3. As the actual next state 218 from the first resource subset 124a is determined by the first sequencing element 200a, it is presented as the actual previous state to the second sequencing element 200b. The sequencer multiplexer 217 of the second sequencing element 200b then is able to make its selection of the actual next state 218 from the second resource subset 124b and presents it to the third sequencing element 200c. Accordingly, the actual next states 218 ripple through the sequencing elements 200a through 200h. Because all possible next states are already available to the sequencer multiplexers 217, determination of the actual next states 218 are able to ripple through very rapidly. As the 8^{th} sequencing element 200h makes its determination, all resources 124 of the present resource cycle are processed. The actual next state 219 of the 8^{th} sequencing element 200h from a last resource cycle is then stored into the state latch 302. The actual previous state 219 for a next sequencing cycle, therefore, is maintained at the state latch output 304 in preparation for the next resource cycle. As one of ordinary skill in the art appreciates from a review of FIGS. 2 and 3, the look up table processing for each resource subset 124a through 124h occurs in parallel and provides each of the sequencer multiplexers 217 with all possible next states at the respective inputs 213 through 216.

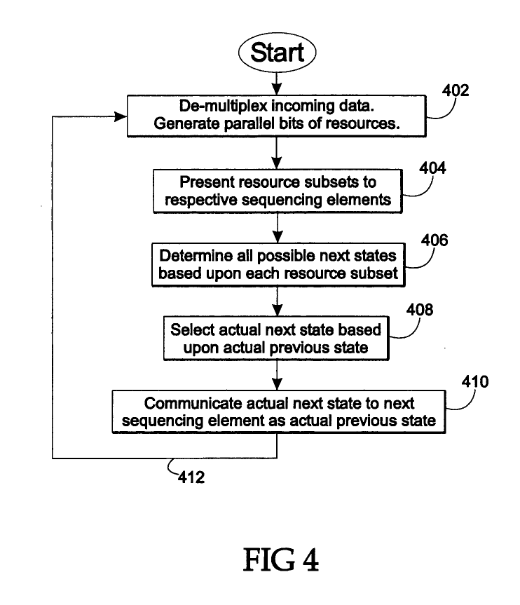

With specific reference to FIG. 4 of the drawings, there is shown a flow chart of the process according to the present teachings. In a specific example of a logic analyzer that uses a sequencer according to the present teachings, there are N bits of incoming data 106 from the DUT 108 and the DUT clock 110 and six user specified pattern matches. The resource generator 123 compares each of the 8 de-multiplexed data states against the 6 patterns matches to generate 6 compare results bits per data cycle. For 8 to 1 de-multiplexing 402, the resource generator 122, therefore, generates 6×8=48 bits of resource 124 for presentation to the sequencer 102. Each of eight sequencing elements 200 receives a 6-bit resource subset 124 a through 124h, respectively. The resource subsets 124a through 124h are presented 404 simultaneously to the respective sequencing elements 200a through 200h. The look up tables 201 through 204 in each sequencing element 200a through 200h determine 406 all possible next states 205 through 208 for each respective resource subset 124a through 124h. Each possible next state 205 through 208 are latched into sequencing registers 209-212 in each sequencing element 200a through 200h and are thereby made available at the input of the sequencer multiplexer 217. As the actual previous state 219 is made available from a previous sequencing element, the sequencer multiplexer 217 selects 408 one of the possible next states available at its input as the actual next state 218. As each actual next state 218 from a previous sequencing element 200 is communicated 410 to the next sequencing element 200, the sequencing multiplexers 217 make the appropriate actual next state selection and ripples the actual next state 218 as the actual previous state 219 through the sequencer 102. The actual next state 218 of the 8^{th} sequencing element 200h is latched into state latch 302 and is presented as the actual previous state 219 to the 1^{st} sequencing element 200a for use in the next resource cycle. The process of determining all possible next states, selecting an actual next state and communicating the actual next state 218 as the actual previous state 219 to the next sequencing element 200 repeats 412.

As part of the sequencer processing, a logic analyzer counter starts at some programmable value and may be decremented by any sequencing element 200a through 200h based upon a value of the resource subsets 124a through 124h. As an example, a logic analyzer may be programmed to trigger after some number of matches to a particular pattern or range. To perform such a function, the counter is loaded with a value and the value is decremented for each match until the counter reaches a terminal count at which time it performs the programmed function. When the counter reaches the terminal count, the sequencer 102 performs the action according to one programmed for the terminal count condition. To implement the counter in a sequencer embodiment according to the present teachings, each sequencing element 200 processes the counter for each respective resource subset. A logic analyzer counter is desirably of a significant width. The wider the counter, however, the more time required for counter processing. In a specific embodiment, the counter is a 24-bit element. In order to reduce the amount of circuitry and processing time to process the counter, the 24-bit counter is reduced to a 4-bit counter proxy that is used within each one of the sequencing elements 200. The counter proxy is established by reduction OR'ing the highest 21 bits of the counter as the 4^{th} bit, with the lowest 3 bits of the counter used as is. Because the sequencer 102 in a specific embodiment operates on 8 cycles of data within a single resource cycle, the 4-bit counter proxy is sufficient information to determine if the counter reaches terminal count within the 8 data cycles and to process through all sequencing elements 200 without losing counter coherency.

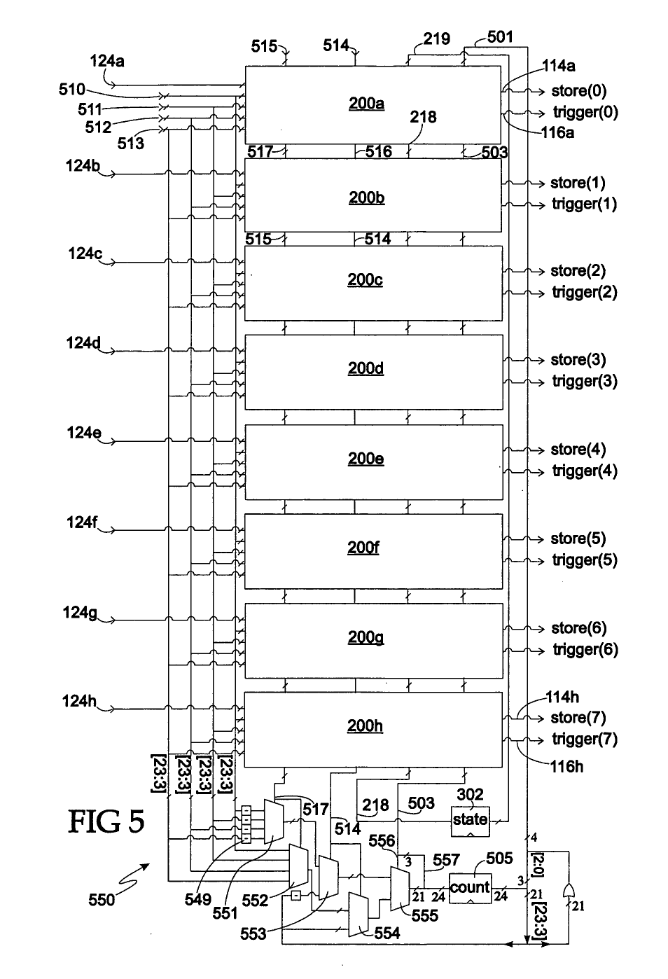

With specific reference to FIG. 5 of the drawings, there is shown another embodiment of the sequencer 102 that includes circuitry for processing the counter and counter proxy. The counter proxy is processed by each sequencing element 200a through 200h as a straightforward 4-bit counter. After all eight sequencing elements 200 have processed the resources 124 and the counter proxy, counter clean-up circuitry 550 restores the coherency of the full 24-bit counter in preparation for processing the next resource cycle. During resource processing, there are certain conditions that cause the counter to be reset by the sequencing elements 200. As an example, the counter may be counting pattern or range matches in the data, but also is programmed to be reset if another pattern is found. In the event of a reset, the counter is loaded with a reset value. In a specific logic analyzer implementation, there are first, second, third and fourth 24-bit counter reset values 510, 511, 512, and 513, received by each sequencing element 200. In the event of a reset condition, the sequencing element 200 selects one of the counter reset values 510 through 513 depending upon a current state of the sequencer 102. A 4-bit previous counter proxy 501 is received by each sequencing element, for example 200b, from a previous sequencing element, for example 200a. Each sequencing element 200 calculates the next counter proxy 503 based upon the respective resource subset 124 and the previous counter proxy value 501. The next counter proxy 503 is presented as the previous counter proxy 501 to the next sequencing element 200. A counter register 505 stores the current counter value for presentation to the 1^{st} sequencing element 200a in the next resource cycle. Because the sequencing elements 200 process the counter proxy, there is counter clean-up circuitry disposed at the output of the 8^{th} sequencing element 200 for restoring the coherency of the 24-bit value maintained in the counter register 505. Accordingly, the counter register 505 maintains the correct counter value for each resource cycle.

A reset of the sequencer 102 based upon the resources 124 causes the counter to be reset. The counter may be reset to a different reset value depending upon a current state of the sequencer 102. Accordingly, in a 4-state sequencer, there are four respective counter reset values 510 through 513. A 1-bit reset and a 2-bit reset state are rippled through the eight sequencing elements 200 to maintain the reset information over the resource cycle for the counter clean-up circuitry 550. The beginning of the resource cycle has no reset, so logic “0”s are established as a first reset in 514a and reset state in 515a. As the signals are rippled through each sequencing element 200, each sequencing element 200 accepts the reset in 514 and reset state in 515 signals from the previous sequencing element 200. If no reset occurs within the sequencing element 200, the reset in 514 and state reset in 515 are passed through to the next sequencing element 200 unchanged as reset out 516 and state reset out 517. During a current resource cycle, a previous counter value 501 is decremented or not depending upon the resources 124a and is passed to the next sequencing element 200 as a next counter value 503, which is received by the next sequencing element 200 as the previous counter value 501. If a reset occurs as a result of the respective resource subset 124a through 124h, the sequencing element 200 sets the reset out 516 for presentation as the reset in 514 to the next sequencing element 200 indicating that a reset has occurred within the current resource cycle. In the event of a reset, the sequencing element 200 also sets the reset state out 517 indicating the state in which the reset occurred. The reset state out 517 is presented to the next sequencing element 200 as the reset state in 515. The sequencing element 200 further resets the counter proxy out 503 to an appropriate counter proxy reset value based upon one of the counter reset values 510 through 513 as determined by the sequencing element next state. After the reset state 517 and reset signals 514 are processed by all sequencing elements 200, the counter clean-up circuitry 550 restores the coherency of the counter value for the next resource cycle. Because the sequencing elements 200 treat the 4 bit counter proxy as a straightforward counter, the highest bit of the 4-bit counter proxy out 503 from the last sequencing element 200h is an indication of whether a borrow has occurred within the last resource cycle against the highest 21 bits of the counter for which the highest 4^{th} bit is a proxy. Specifically, a borrow on the highest bit of the 4 bit count proxy has occurred when the 4^{th} bit of the count proxy out 503 of the last sequencing element is a “0”). A zero value for the 4^{th} bit of the count proxy out 503 for the last sequencing element, therefore, indicates a decrement of the highest 21 bits of the counter in preparation for the next resource cycle. If no borrow is made on the highest bit of the 4 bit counter proxy out 503, i.e. when the value of the 4^{th} bit of the count proxy out is a “1”, no decrement is indicated for the highest 21 bits of the counter. The counter clean up circuitry calculates the correct value of the upper 21 bits of the counter in the event of a reset by accepting the upper 21 bits of each counter reset value 510-513, decrementing 549 each value by one, and presenting the decremented values to a 4:1 first state counter multiplexer 551. The same upper 21 bits of each counter reset value are also presented un-decremented to 4:1 second state counter multiplexer 552. Selection of which of the four possible inputs into the decrement reset counter multiplexer 551 and the reset counter multiplexer 552 is made using the state reset out 517. Therefore, there are two possible upper 21 bits of the counter available at the output of the first and second state counter multiplexers 551, 552 representing the upper 21 bits of the counter if there were a reset and a borrow indicated by the proxy and if there were a reset but no borrow indicated by the proxy. Also pre-calculated in the counter clean up circuitry are the decremented and un-decremented values of the current counter. The decremented and un-decremented values of the current counter are presented as inputs to respective first and second reset multiplexers 553, 554. The other input to the first and second reset multiplexers 553, 554 is the output of the respective first and second state counter multiplexers 551, 552. Selection of which value is presented at the output of the first and second reset multiplexers 553, 554 is made based on the reset out 514 of the last sequencing element 200h. Accordingly, the outputs of the first and second reset multiplexers provide the correct upper 21 bits of the counter for the decremented and undecremented conditions having already processed any reset condition. The outputs of the first and second reset multiplexers 553, 554 are presented to borrow selection multiplexer 555. A proxy bit 556 of the counter proxy out 503 from the last sequencing element 200h provides selection of which of the inputs presented to the borrow selection multiplexer 555 is presented at its output. If the proxy bit 556 has a 0 value, a borrow has occurred at some point in the last resource cycle and the decremented selection of the correct upper 21 bits of the counter is made. If the proxy bit 556 has a 1 value, a borrow has not occurred and the undecremented selection of the correct upper 21 bits of the counter is made. The output of the borrow selection multiplexer 555, therefore, represents the correct upper 21 bits of the counter after reset and borrow processing. The output of the borrow selection multiplexer 555 is recombined with the lowest 3 bits of the count out 503 for storage in the counter register 505, which is latched at the next clock edge. Accordingly, a value in the counter register 505 reflects the correct counter value. The lowest 3 bits of the counter register 505 are then fed back as the lowest 3 bits of the previous counter proxy value 501 for the first sequencing element 200a in the next resource cycle. The upper 21 bits of the counter register 505 are reduction OR'd as the counter proxy bit of the previous counter proxy value 501 for the first sequencing element 200a in the next resource cycle. The upper 21 bits are also presented to the clean up circuitry 550 for use in counter processing in the next resource cycle.

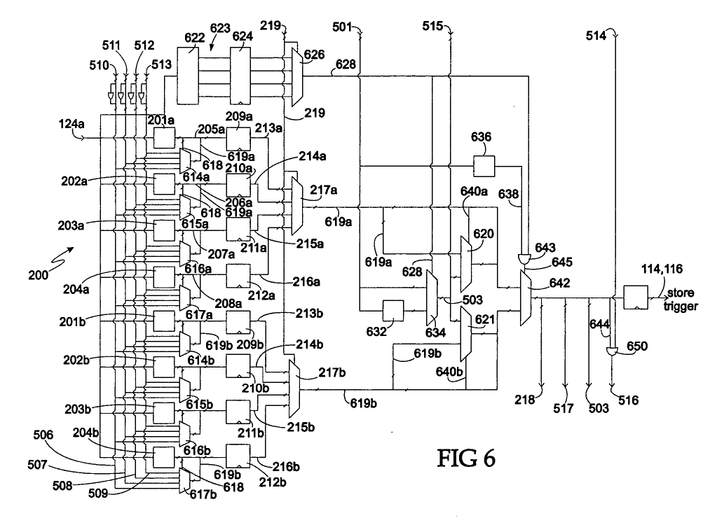

With specific reference to FIG. 6 of the drawings, there is shown an embodiment of a sequencing element 200 according to the present teachings. The embodiment of FIG. 6 is configured to implement the same 4-state state machine as shown in FIG. 3 of the drawings, but also to handle counter processing as discussed with respect to FIG. 5. In the embodiment of FIG. 6, there are first and second sets of the four look up tables in each sequencing element 200. A first set of look up tables 201a through 204a determine four possible next states 213a through 216a based upon the resources subset 124a when a terminal count condition is false. The second set of four look up tables 201b through 204b determine the four possible next states 213b through 216b based upon the resources subset 124a when a terminal count condition is true. Each set of look up tables 201a through 204a and 201b through 204b has respective sequencer multiplexers 217a and 217b associated with it. Each sequencer multiplexer 217a, 217b receives the actual previous state 219 to control selection of each sequencer multiplexer output. The embodiment of FIG. 6 also has a counter look up table 622 that accepts the same resource subset 124a as presented to the look up tables 201a through 204a and 201b through 204b. The counter look up table 622 determines four possible 1-bit decrement signals 623 indicating whether the counter is to be decremented or not based upon the resources subset 124a for each possible state. The four possible decrement signals 623 are stored into 4-bit decrement latch 624. Counter multiplexer 626 accepts the four possible decrement signals 623 and makes selection of the actual decrement signal 628 based upon the actual previous state 219. The previous counter proxy 501 is received by the sequencing element 200 from the previous sequencing element 200. The previous counter proxy 501 is checked against a value of 1 at counter compare 636. If the previous counter proxy 501 is equal to 1, the counter compare 636 presents a 1 at a counter compare output 638. If the previous counter proxy value is equal to anything except 1, the counter compare 636 presents a “0” at its output 638. The counter compare output 638 and actual decrement control signal 628 are inputs into 2-input AND terminal count gate 643. An output of the terminal count gate 640 provides a terminal count status 645 that indicates whether the counter is at its terminal count. If so, terminal count multiplexer 642 selects the output of sequencer multiplexer 217b related to a terminal count status of true. If not, the terminal count multiplexer 642 selects the output of sequencer multiplexer 217a related to a terminal count status of false.

As part of the counter processing in the sequencing element 200, the sequencing element 200 accepts the lowest 3 bits of each counter reset value 510 through 513 including a reduction OR'd result of the upper 21 bits as first through fourth counter reset proxies 610-613. Each look up table 210 through 204 has associated with it, a respective counter reset proxy multiplexer 614a through 617a and 614b through 617b. Selection of an appropriate possible counter reset proxy 619 for each possible state is made by a next state output 618 of each look up table 201a through 204a and 201b through 204b. The possible counter reset proxy value 619 is combined with the output of the respective look up table 201a through 204a and 201b through 204b, which includes 2 bits of next state information, store, trigger, and reset, for a total of 9 bits of information. Selection of an appropriate counter reset proxy for the terminal count false 619a and terminal count true 619b conditions is, therefore, made by the sequencing multiplexers 217a, 217b as part of the actual next state 218, store 114, trigger 116 and reset determination. The two possible counter reset proxies 619a, 619b as well as the two possible next states as calculated by the look up tables 201a-204a and 201b-204b are presented to first and second proxy/reset multiplexers 620, 621. The other input to the first and second proxy/reset multiplexers 620, 621 is the actual counter proxy 503. The actual counter proxy 503 is processed by the sequencing element 200 by accepting previous counter proxy value 501, decrementing it by one at reference numeral 632 and then presenting the decremented value to decrement multiplexer 634. The un-decremented counter proxy 501 is also presented to the decrement multiplexer 634. Selection between the decremented counter proxy value from 632 versus the un-decremented counter proxy value is made with actual decrement signal 628. As described above, selection between the decremented/un-decremented counter proxy and the counter reset proxy 619a, 619b for the terminal count conditions of true and false is made by current reset 640a, 640b at first and second proxy/reset multiplexers 620, 621. The outputs of the first and second proxy/reset multiplexers 620, 621 provide the two possible counter proxies, store, trigger, next state, reset for the terminal count conditions of true and false. The two possible grouping are selected using the terminal count multiplexer 642 to determine the actual counter proxy 503, store 114, trigger 116, actual next state 218 and current reset 644. The current reset 644 is conjunctively combined at reset AND gate 650 before presentation as the reset out 516.

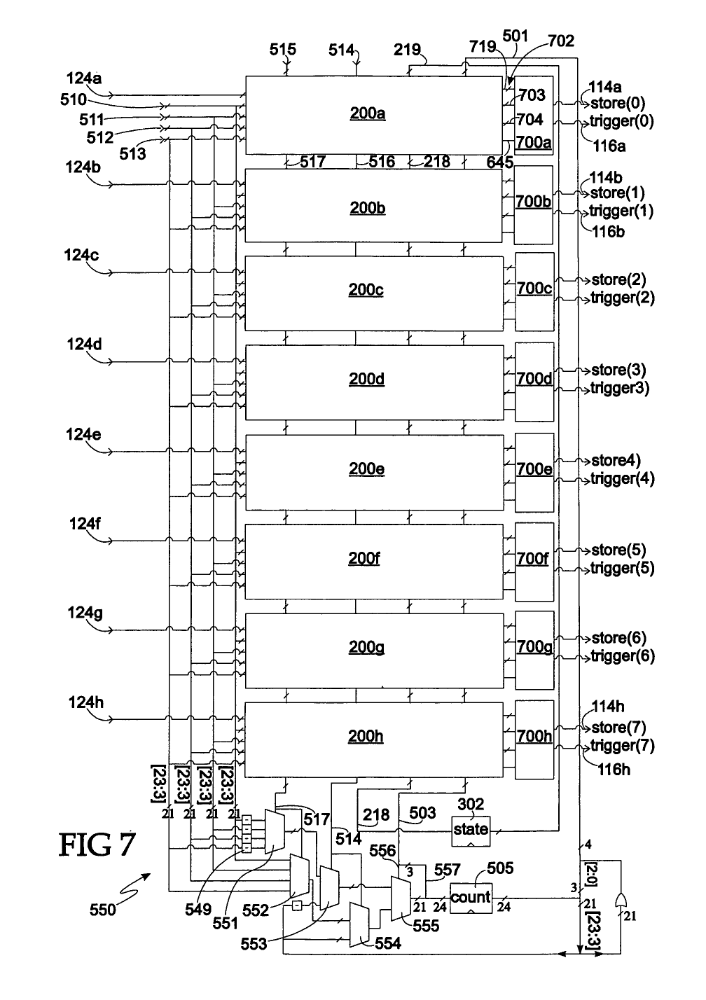

With specific reference to FIG. 7 of the drawings, there is shown another embodiment of a sequencer 102 according to the present teachings wherein a determination of the store and trigger 114, 116 is removed from the next state, count and reset determinations and placed in a parallel functional block. In the embodiment of FIG. 7, there are primary and secondary sequencing elements 200, 700 that communicate across sequencing element interface 702. In an embodiment that uses 8:1 data to resource de-multiplexing, there are eight of the primary sequencing elements 200a through 200h communicating with eight of the secondary sequencing elements 700a through 700h over respective sequencing element interfaces 702a through 702h. Each sequencing element interface 702 comprises a state on 719, which is a latched value of the actual previous state 219, a store array 703 comprising the store signal for each possible next state for the terminal count true condition and the store signal for each possible state for the terminal count false condition, a trigger array 704 for each possible next state for the terminal count true condition and the trigger signal for each possible state for the terminal count false condition, and the terminal count status 645. The store and trigger arrays 703, 704 are 8-bits each. The secondary sequencing element 700a accepts the state on 719, the store and trigger arrays 703, 704 and terminal count array 645 and determines the store 114 and trigger for each sequencing element 200/700. The inputs into each sequencing element and the counter clean-up circuitry are the same as shown and described in FIGS. 5 and 6.

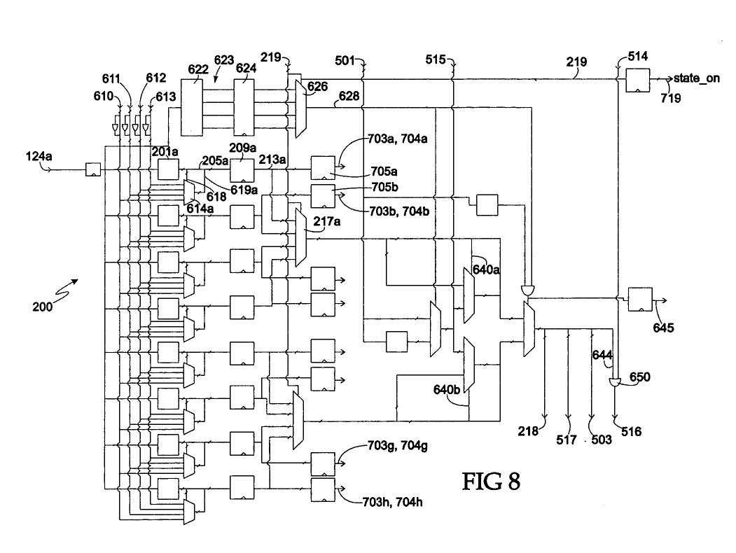

With specific reference to FIG. 8 of the drawings, there is shown an embodiment of the primary sequencing element 200 according to the present teachings wherein an adaptation is made from the sequencing element of FIG. 6 by bringing out a possible store and trigger 703, 704 from each look up table output and latching it into a store/trigger memory element 705. Each look up table is related to a respective one of the store/trigger memory elements 703, 704. In a specific embodiment where there are two distinct sets of look up tables for true and false terminal count conditions, there are also possible store and trigger 703, 704 for both terminal count conditions. Accordingly, in the illustrated embodiment, look up table 201a is related to possible store bit 703a and possible trigger bit 704a, look up table 202a is related to possible store bit 703b and possible trigger bit 704b and look up table 204b is related to possible store bit 703h and possible trigger bit 704h.

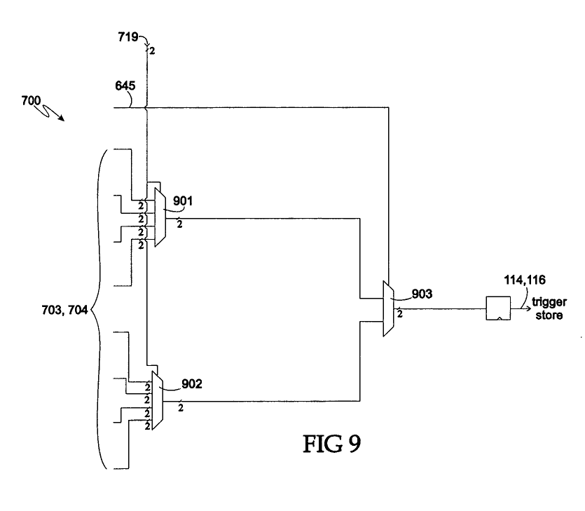

With specific reference to FIG. 9 of the drawings, the secondary sequencing element 700 performs final determination of the store 114 and trigger 116 for each primary sequencing element/secondary sequencing element 200/700 combination. Each secondary sequencing element 700 accepts the store 703 and trigger 704 arrays over the sequencing element interface 702. The possible store and trigger bits for a terminal count condition of false are presented to a first secondary sequencing element multiplexer 901. Similarly, the possible store and trigger bits for a terminal count condition of true are presented to a second secondary sequencing element multiplexer 902. Selection of an appropriate one of the possible store and trigger bits is made using the state on 719 signal for the terminal count false and true conditions. Determination of the final store 114 and trigger 116 is made by presentation of the appropriate store and trigger bits for the terminal count conditions of false and true to a tertiary secondary sequencing multiplexer 903 with selection made using the terminal count 645. An output of the tertiary secondary sequencing multiplexer 903 is the store/trigger 114, 116 for the primary and secondary sequencing element 200/700 combination.

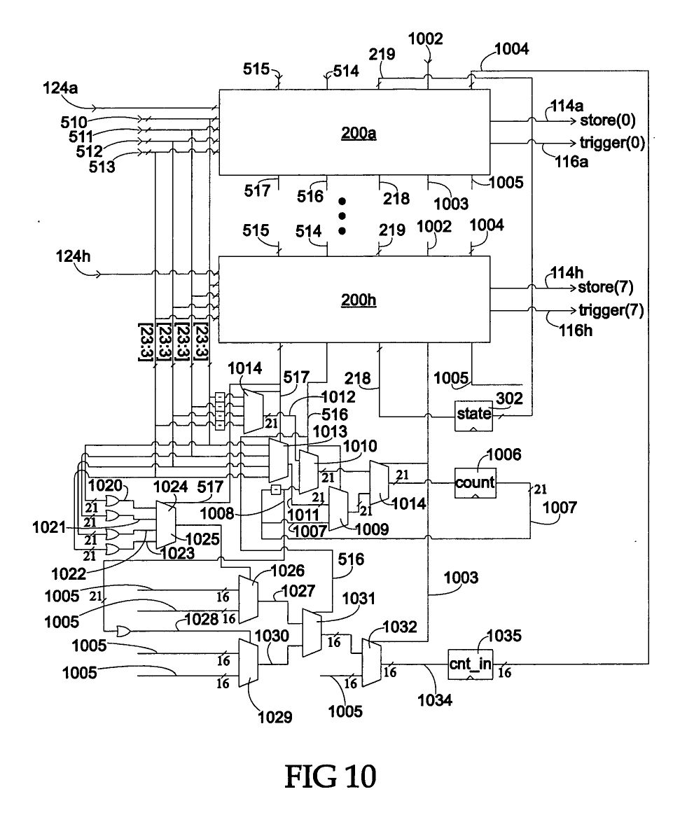

With specific reference to FIG. 10 of the drawings, there is shown an embodiment of a sequencer 102 in which is implemented a 16-bit one-hot counter proxy instead of a 4-bit counter proxy. The illustration of FIG. 10 shows an unpipelined sequencer based upon the sequencer shown in FIG. 5. The 16-bit one hot counter proxy, however, may also be used with a pipelined sequencer. A specific embodiment of a pipelined sequencer according to the present teachings is shown in FIGS. 7 through 9. Reference numerals having the same number represented in FIGS. 1-9 represent the same elements in FIGS. 10-14 of the drawings. Reference numerals found in FIGS. 10-14 that are not found in FIGS. 1-9 refer to elements illustrates as part of the one hot counter proxy implementation.

In the embodiments illustrated that have eight sequencing elements 200, a maximum of 8 decrements is possible during the eight cycles through the 8 sequencing elements 200. As such, only the lower 3 bits of the 24-bit sequencer counter plus one bit of information regarding whether a borrow occurred on the upper 21 bits needs to be carried through the sequencing elements 200 in order to maintain all information regarding the sequencer counter. In the one hot counter proxy embodiment, the lowest 3 bits of the sequencer counter plus the proxy bit representing the upper 21 bits of the sequencer counter is carried through the sequencing elements 200 as 16-bits in a one hot representation. Counter latency is decreased relative to the 4-bit counter embodiment because detection of a terminal count condition is performed by simple logic detection in the least significant bit. In addition, the counter decrement operation is reduced to a shift operation. If the counter operations are part of the critical path of the sequencer 102, decreasing the latency of the counter operations increases the operating speed of the sequencer 102. As one of ordinary skill in the art appreciates, the latency is decreased at the expense of greater logic area required to ripple a larger number of bits through the sequencing elements 200 to maintain counter coherency.

After 8 cycles, the one hot counter results are synchronized with the 24-bit counter by decrementing, maintaining, or resetting a high order counter subset 1007, which in the present embodiment is the upper 21 bits of the counter, and by decrementing, maintaining, or resetting the 16-bit one hot representation as indicated by the results of the previous 8 cycles and in preparation for the next 8 cycles through the sequencer 102. With specific reference to FIG. 10, there is shown counter synchronization logic for the 24-bit sequencer counter and 16-bit one hot counter proxy embodiment. In the embodiment of FIG. 10, the counter proxy is represented as 16-bits where only 1 bit is a logic 1 at any one time and each bit location represents a different value of the counter. The 16-bit proxy counter represents a one hot representation of the lower 3 bits of the sequencer counter value and the 4^{th} proxy bit as previously described that represents whether a borrow occurred on the upper 21 bits during the 8 cycles. The 16-bit one hot proxy counter replaces the 3-bit counter plus one bit to indicate a borrow and is illustrated in FIG. 10. In the one hot representation, a logic 1 in the bit 0 position of the one hot proxy represents a value of 1. A logic 1 in the bit 1 position of the one hot proxy represents a value of 2, a logic 1 in the bit 7 position of the one hot proxy represents a value of eight, and a logic 1 in the bit 15 position of the one hot proxy represents a value of sixteen. FIG. 10 illustrates 1^{st} and 8^{th} sequencing elements 200a and 200h, respectively, and for clarity, does not show the middle 6 sequencing elements 200b through 200g. Each of the six intermediate sequencing elements 200b through 200g are configured and interconnected as shown with respect to the first and eighth sequencing elements 200a and 200h. In FIG. 10, 16 bits of the one hot proxy are propagated through each one of the sequencing elements 200. Each sequencing element 200, therefore, accepts a count in 1004 from the counter synchronization logic or the previous sequencing element 200 and passes a count out 1005 to the next sequencing element 200 or to the synchronization logic. Additionally, a borrow in 1002 is received by the previous sequencing element 200 and a borrow out 1003 is passed to the next sequencing element 200. Because the borrow in 1002 represents whether the previous sequencing element 200 performed a decrement that borrowed against the upper 21 bits of the sequencer counter and because a borrow cannot have occurred before the first of 8 sequencer cycles, the borrow in 1002 for the first sequencing element 200a is hard wired to a logic zero. As one of ordinary skill in the art appreciates, in embodiments where more than 8 sequencing elements 200 comprise the iterative logic array that comprises the sequencer 102, the number of bits in the proxy counter may be adjusted accordingly. For example, if there are sixteen sequencing elements, the counter proxy may be represented as 4 bits plus a proxy bit, which may be further represented as a 32-bit one hot proxy counter.

Each sequencing element 200 performs one of three possible functions on the counter proxy; (1) decrement the proxy count by one, (2) reset the proxy count to a counter reset value and (3) maintain the same proxy count. Each sequencing element 200 also detects whether the count is zero meaning that the counter has reached a terminal count. In the one hot embodiment, a decrement by one is performed quickly as a shift by one of the proxy counter and a zero detection is performed by identification of a logic one in the bit 0 position of the proxy counter coupled with a decrement operation.

The upper 21 bits of the sequencer counter is kept in counter latch 1006. At the end of 8 cycles through the sequencing elements 200, the counter latch 1006 is loaded with an updated count depending upon a status of the one hot proxy counter and the borrow out 1003. An undecremented value of the high order subset 1007 of the sequencer counter and a decremented by one sequencer counter value for the high order subset 1008 are presented to first and second reset 2:1 multiplexers 1009, 1010 respectively. The decrementing function performs a decrement only if the value input into the decrementer is 1 or greater. If the value is 0, no decrement occurs. Also presented to the first and second reset multiplexers 1009, 1010 is an undecremented and decremented selected counter reset value 1011, 1012 respectively. The selected counter reset values 1011, 1012 are outputs of first and second state select reset 4:1 multiplexers 1013, 1014 respectively. Inputs presented to the first state select reset multiplexer 1013 are undecremented values of the four counter reset values 510 through 513. Inputs presented to the second state select reset multiplexers 1014 are decremented values of the four counter reset values 510 through 513. The state reset out signal 517 makes selection of which counter reset value 510 through 513 is presented at the output of the first and second state select reset multiplexers 1013, 1014. The reset out 516 signal selects which value is presented at the output of the first and second reset multiplexers 1009, 1010. The outputs of the first and second reset multiplexers 1009, 1010 are presented to borrow multiplexer 1014. A logic 1 in the borrow out 1003 indicates that the upper 21 bits of the current counter value is decremented by one. Accordingly, the borrow out 1003 from the 8^{th} sequencing element 200h selects whether the decremented or undecremented value of the counter value is presented as the newly calculated upper 21 bits of the sequencer counter to be latched into counter latch 1006 in preparation for the next 8 sequencer cycles.

The lower 3 bits of the sequencer counter in combination with a proxy bit are synchronized in the 16-bit one hot configuration before presentation to the first sequencing element 200a in preparation for the next 8 sequencer cycles. In the illustrated embodiment, the 16-bit one hot configuration is preserved during the synchronization process for the lower 3 bits of the sequencer counter. It is possible during the last 8 cycles of the sequencer 102 that the sequencer counter is reset. Therefore, the synchronization process includes accommodation of the reset function. The upper 21 bits of each of the four counter reset values 510 through 513 are reduced by combining them with a disjunctive OR function to generate first through fourth counter reset value proxy bits 1020 through 1023 for state0 through state3, respectively. As one of ordinary skill appreciates, if any of the upper 21 bits are a logic one, the resulting proxy bit is also a logic one. Accordingly, the proxy bit provides indication to the proxy function that the sequencer counter value is greater than eight. The first through fourth counter reset value proxy bits 1020 through 1023 are presented to 4:1 proxy bit reset multiplexer 1024. Selection of which of the counter reset value proxy bits 1020 through 1023 is presented at the output of the proxy multiplexer 1024 is made using the state reset out 517. If a selected counter reset value proxy bit 1025 is a logic zero, the corresponding counter reset value may be completely represented by the lowest 8 bits of the current 16-bit one hot count out 1005. Accordingly, eight zeros are loaded into the upper 8 bits of the 16-bit one hot proxy counter and the lower 8 bits remain unchanged as the lower 8 bits of the one hot proxy counter. If the selected counter reset value proxy bit is a logic one, the current value of the sequencer counter for purposes of processing over the next 8 sequencer cycles is represented by eight added to the lowest 8 bits of the current 16-bit one hot count out 1005. In the one hot configuration, an add eight function is performed as a shift 8 of the lowest 8 bits of the one hot representation. Accordingly, eight zeros are loaded into the lower 8 bits of the 16-bit one hot proxy counter and the lower 8 bits of the count out 1005 are loaded into the upper 8 bits of the 16 bit one hot proxy counter in preparation for the next 8 cycles. Determination of a counter reset value 1027 is performed with the counter reset value proxy multiplexer 1024 and one hot reset calculation multiplexer 1026. A similar determination is made using the upper 21 bits of the sequencer counter decremented by 1 for purposes of counter synchronization that does not involve a counter reset event but does involve a borrow against the upper 21 bits of the count value. The upper 21 bits of the decremented by 1 sequencer counter value 1008 are combined in an OR function to generate a counter proxy bit 1028 for the decremented value. Counter decrement multiplexer 1029 receives 2 inputs of 16 bits where a first input comprises the lower 8 bits of the count out 1005 in the upper 8 bits of the counter proxy value and a second input that comprises the lower 8 bits of the count out 1005 in the lower 8 bits of the counter proxy value. The counter proxy bit 1028 of the decremented counter value selects which of the inputs to the counter decrement multiplexer 1029 is presented at its output as a decremented counter value 1030. The reset out 516 from the 8^{th} sequencing element 200h selects between the counter reset value 1027 and the decremented counter value 1030 in reset multiplexer 1031. The borrow out 1003 from the 8^{th} sequencing element 200h then controls selection through borrow multiplexer 1032 of the count out 1005 or the output of the reset multiplexer 1031. Output of the borrow multiplexer is new one hot counter proxy 1034 which is latched into proxy latch 1035 for presentation to the first sequencing element 200a as the count in 1004.

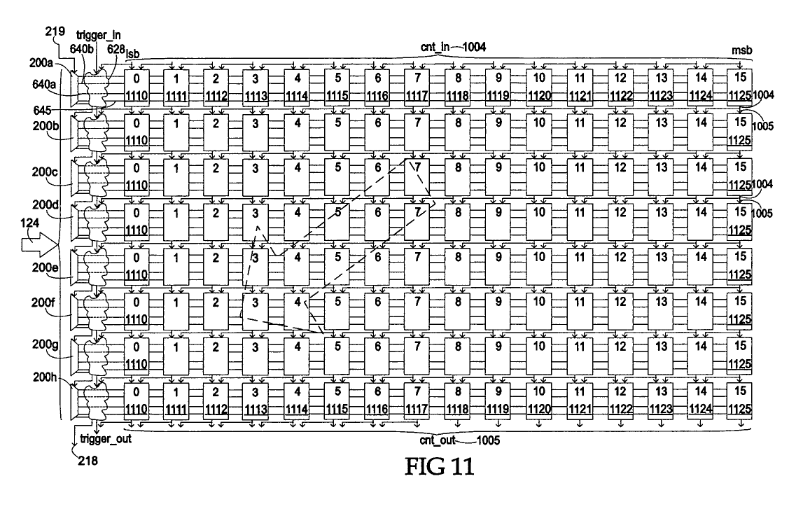

With specific reference to FIG. 11 of the drawings, there is shown a representation of the 16-bit one hot counter logic present in each of the sequencing elements 200. For purposes of clarity, the logic present in the sequencing elements 200 unrelated to the one hot counter decrementing operation is shown as a multiplexer and logic cloud while the interaction between one hot counter logic between sequencing elements is illustrated is more detail. Each sequencing element 200 receives the 16-bit count in 1004. One hot bit logic cells 1110 through 1125 comprises the same logic and each cell receives a respective bit and a respective next significant bit of the count in 1004. Specifically, one hot logic cell 1110 receives bit0 and bit1 of the count in 1004, one hot logic cell 1111 receives bit1 and bit2, one hot logic cell receives bit2 and bit3, et seq. One hot logic cell 1125 is the most significant bit and because there is no more significant bit, it receives only bit15. A decrement of the count in 1004 comprises a shift operation from the most significant bit to the next less significant bit and then passes the shifted value as the count out 1005. The count out 1005 is received as the count in 1004 by the next sequencing element 200. As decrements occur over the eight cycles of the sequencer 102, a logic 1 is rippled through the iterative logic array towards the least significant bit at the last sequencing element 200h of the array.

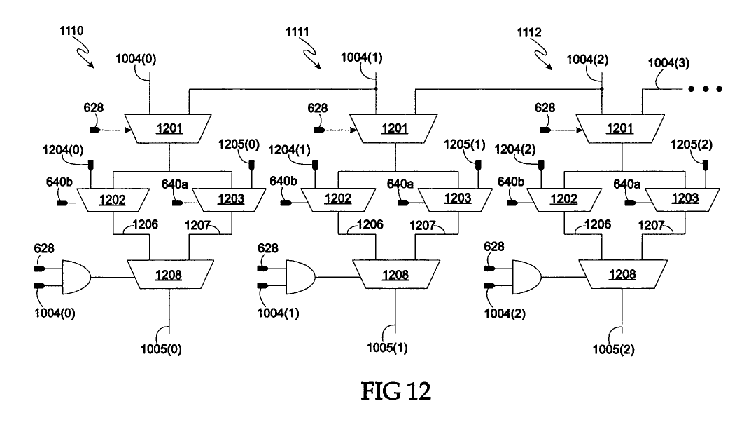

With specific reference to FIG. 12 of the drawings, there is shown three adjacent one hot logic cells that are illustrative of the 128 one hot logic cells that make up the one hot counter processing logic portion of the eight sequencing elements 200. Each one hot logic cell 1110 through 1124, with the exception of the bit15 one hot logic cell 1125, receives two bits of the count in 1004 and transmits one bit of the count out 1005 to the next sequencing element 200. The illustration of FIG. 12, shows the one hot logic cell 1110 for bit0 of the count in 1004, shown in the illustration as 1004(0) and bit1 of the count in 1004, shown in the illustration as 1004(1). Description of the bit0 one hot logic cell adequately describes bit1 through bit 15 one hot logic cells. Accordingly, only the bit0 one hot logic cell is described in detail. Decrement multiplexer 1201 receives bit0 1004(0) and a next significant bit 1004(1) of the count in 1004. The decrement signal 628 from the sequencing element 200 selects which bit is presented at the output of the decrement multiplexer 1201. Parallel ones of the decrement multiplexers 1201 corresponding to the same count in 1004 respond to the same decrement signal 628 and, therefore, perform a parallel shift operation in response to an affirmative decrement 628 and maintain the count in 1004 in response to a negative decrement 628. A next level of parallel multiplexers comprise first and second reset multiplexers 1202, 1203. Both of the reset multiplexers 1202, 1203 receive the output of the decrement multiplexer 1201 as well as a corresponding bit of a one hot representation of first and second reset counter values 1204(0) and 1205(0). In a specific embodiment, there are two reset conditions 640a, 640b depending upon whether the sequencing element 200 is in a terminal count condition or not. The first reset counter value 1204 is loaded into the sequencer counter in the event of a reset under a terminal count condition. The second reset counter value 1205 is loaded into the sequencer counter in the event of a reset without a terminal count condition. The first reset multiplexer 1202 responds to the reset signal under a terminal count condition 640b. The second reset multiplexer 1203 responds to the reset signal under a no terminal count condition 640a. As with the decrement multiplexer 1201, the first and second reset multiplexers 1202, 1203 in each one hot logic cell 1110 through 1125 respond to the same selection signals in parallel one hot logic cells. Outputs 1206, 1207 of the first and second reset multiplexers 1202, 1203 are presented as inputs to terminal count multiplexer 1208. Selection of the inputs to the terminal count multiplexer 1208 is made using a conjunctive combination of the decrement 628 from the sequencing element 200 and the bit0 of the count in 1004(0). Output from the terminal count multiplexer 1208 comprises bit0 of the count out 1005. Outputs from the terminal count multiplexers 1208 in parallel one hot logic cells 1111 through 1125 operate in parallel to the one hot logic cell 1110 and provide bit1 through bit 15 of the count out 1005.

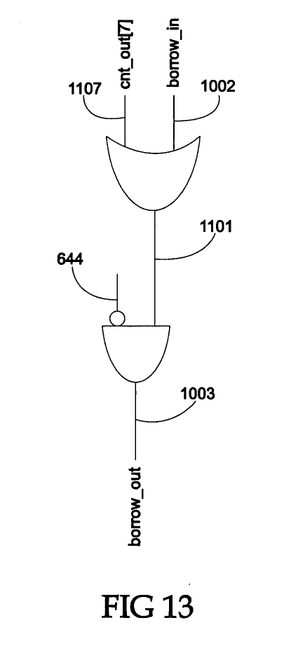

The borrow out 1003 indicates whether a borrow has been made against the upper 21 bits of the sequencer counter during the 8 cycles of the sequencer 102. A borrow in 1002 is received by each sequencing element 200 and an asserted borrow out 1003 is propagated through all remaining sequencing elements 200 of the sequencer 102 unless it is reset after the borrow out 1003 is asserted. Determination of whether a borrow occurs on the upper 21 bits of the counter is made when a logic 1 is found in the bit7 of the 16-bit one hot counter representation during counter processing within any one of the sequencing elements 200. With specific reference to FIG. 13 of the drawings, there is shown the logic present in all of the sequencing elements 200 for detecting a borrow event, processing a reset event, if any, and propagating the borrow event to the next sequencing element 200 as the borrow out 1003. Each sequencing element 200 receives the borrow in 1002. The borrow in 1002 is OR'd with the 7^{th} bit 1107 of the count out 1005 after calculation of the next count and before it is transmitted to the next sequencing element 200 as the count out 1005. Because of the one hot counter function, a logic 1 present in the 7^{th} bit 1107 of the count within the sequencing element 200 indicates that a logic 1 has crossed the 8^{th} bit to 7^{th} bit boundary during any one previous cycle of the sequencing elements 200. An output of the OR function is presented as an asserted borrow 1101. Accordingly, the asserted borrow 1101 is a logic 1 when an asserted borrow in 1002 is received or if the 7^{th} bit 1107 contains a logic 1. The asserted borrow 1101 is AND'd with an inverse of the reset bit 644. If no reset is received, the asserted borrow 1101 is presented as the borrow out 1003 of the sequencing element 200, which is then received as the borrow in 1002 of the next sequencing element 200. If a reset occurs, the asserted borrow 1101 is not presented as the borrow out 1003 and the borrow out 1003 is presented as a logic 0 to the next sequencing element 200.

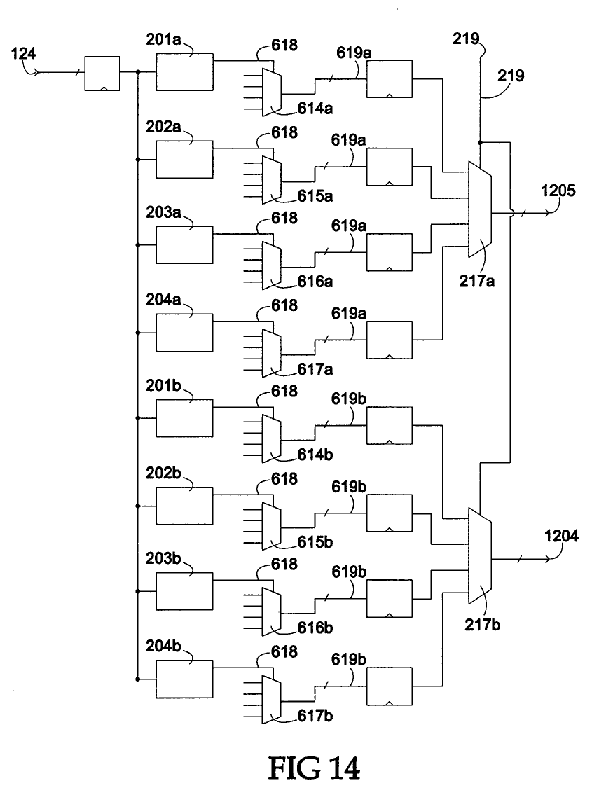

FIG. 14 of the drawings shows a modification of the logic of FIG. 6 or FIG. 8 for implementation of the one hot proxy counter with either embodiment of the sequencing element 200 that determines reset counter values in a terminal count and no terminal count condition. With specific reference to FIG. 14 of the drawings, there is shown a portion of the sequencing element 200 that receives the resources 124 and presents the resources 124 to the two sets of four look up tables 201a through 204a and 201b through 204b. A next state output 618 of each of the look up tables selects which of four possible counter reset values are presented at the output of the counter reset proxy multiplexers 614a through 617a and 614b through 617b. The selected output of the counter reset proxy multiplexers 614a through 617a and 614b through 617b comprises the possible counter reset proxy 619 for the reset terminal count 619a and reset no terminal count 619b conditions. The actual previous state 219 selects the appropriate counter reset value for the reset terminal count 1204 and reset no terminal count 1205 conditions. Respective ones of the 16-bits of the reset terminal count value 1204 and reset no terminal count value 1205 are presented to the first and second reset multiplexers 1202, 1203 in the one hot logic cells 1110 through 1125.

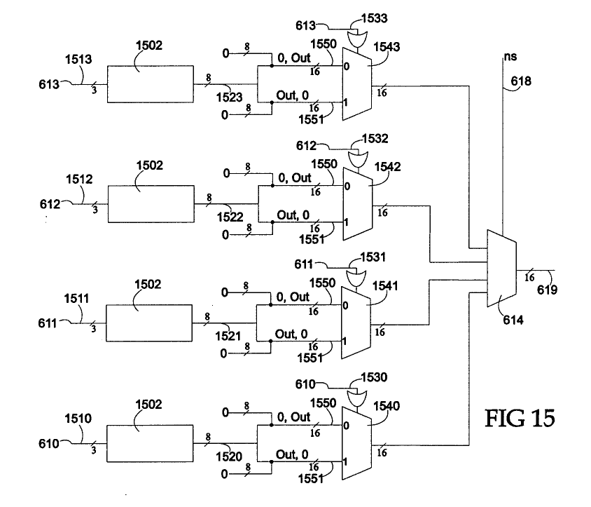

With specific reference to FIG. 15 of the drawings, there is shown logic that is representative a logic feeds the counter reset proxy multiplexers 614a through 617a and 614b through 617b. The logic of FIG. 15, therefore, is replicated for each of the counter reset proxy multiplexers 614a through 617a and 614b through 617b. The logic illustrated converts the 24-bit counter reset values for state0 through state3, 613, 612, 611, 610, respectively, into the respective 16-bit one hot representation. Three bits, bit0 through bit2, from each reset value 610 through 613 are shown as counter reset value low subset 1510 through 1513, respectively. Each counter reset value low subset 1510 through 1513 is presented to a respective memory 1502. Each memory 1502 has the following truth table:

| In[2:0] | Out[7:0] |
|---|---|
| 000 | 00000001 |
| 001 | 00000010 |
| 010 | 00000100 |
| 011 | 00001000 |
| 100 | 00010000 |
| 101 | 00100000 |
| 110 | 01000000 |
| 111 | 10000000 |

An output of the memory 1520 through 1523 comprises an 8-bit wide one hot representation of the corresponding 3-bit input. Each 8-bit one hot representation forms two different inputs into respective add by 8 multiplexers 1540 through 1543. A first input 1550 into each add by 8 multiplexer 1540 through 1543 comprises logic O's loaded into the eight high bits of the 16-bit one hot counter representation and the 8-bit one hot representation loaded into the eight low bits of the 16-bit counter representation. The first input 1550, therefore, comprises the 16-bit one hot counter representation where the proxy bit is 0. A second input 1551 into each add by 8 multiplexer 1540 through 1543 comprises logic 0's loaded into the eight low bits of the 16-bit counter representation and the 8-bit one hot representation loaded into the eight high bits of the 16-bit one hot counter representation. All bits, 21 in the present illustration, of a counter reset value high subset 1530 through 1533 are disjunctively combined to generate a proxy bit. If any one of the bits in the counter reset value high subset is a logic 1, the proxy bit is a logic 1 and the second input 1551 to the add by 8 multiplexers 1540 through 1543 is presented at the output. If all of the bits in the counter reset value high subset are logic 0's, the proxy bit is a logic 0 and the first input 1550 to the add by 8 multiplexers 1540 through 1543 is presented at the output. As one of ordinary skill appreciates, the proxy bit from the counter reset values 610 through 613 performs an add by 8 or not to the 8-bit one hot representation of the counter reset value low subsets 1510 through 1513.

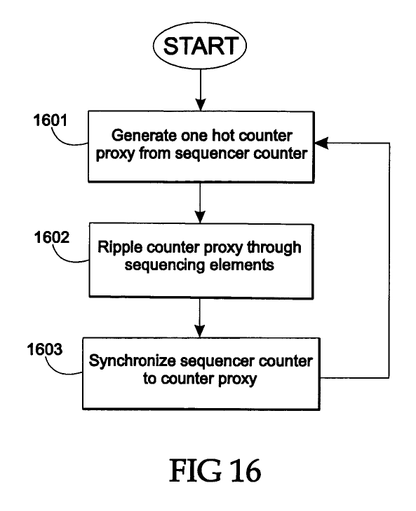

With specific reference to FIG. 16 of the drawings, there is shown a flow chart of a method according to the present teachings for processing the one hot counter proxy in which a first step is generating 1601 a one hot representation of the 24-bit sequencer counter in preparation for processing through the sequencing elements 200. The counter proxy is rippled through 1602 each of the sequencing elements 200. Each sequencing element 200 performs one of three possible functions on the counter proxy: (1) decrementing the count by one, (2) maintaining the count, and (3) resetting the count to a count reset value. When all sequencing elements 200 have completed processing, the sequencer counter is synchronized 1603 using information contained in the proxy counter as well as the state reset out 517, reset out 516, and borrow out 1003.

Embodiments according to the present teachings are described herein by way of illustration. Other embodiments not specifically disclosed and within the scope of the appended claims will occur to one of ordinary skill with benefit of the present teachings. For example, as previously mentioned herein, the present teachings are applicable to many different de-multiplexing factors. De-multiplexing factors larger than 8 to 1 result in a larger circuit area to implement the circuit, however, they may produce better operating speeds. As the de-multiplexing factors increase, the circuit eventually suffers from too many layout parasitic impedances and operating speeds deteriorate. It is found that the 8 to 1 de-multiplexing is currently preferred in view of current technology. In another example of an alternate embodiment, the previous and next states may be represented with 4-bit one hot encoding as opposed to the disclosed 2-bit binary encoding. In that case, the multiplexers illustrated may be replaced with one hot encoded multiplexers. The 4-bit one hot encoding may result in an incremental increase in speed because the binary input multiplexers 217 that process the previous state information may be replaced with logic in each of the sequencing elements 200. The details of embodiments according to the present teachings scale. For example, the one hot counter proxy described herein is described as a 16-bit one hot encoded value. If the sequencer has a multiplexing factor of fewer or more than 8, the one hot encoded counter proxy may use less than or more than 16-bits. The one hot encoded counter may be implemented in pipelined as well as unpipelined embodiment of the sequencer 102.

1. A sequencer comprising:
At least two sequencing elements in rippled combination, each sequencing element processing a subset of de-multiplexed incoming data over a single resource cycle, each sequencing element further processing a counter proxy, said counter proxy representing a sequencer counter and comprising a one hot representation of a low order counter subset added to eight if a high order counter subset is at least one and a low order counter subset if high order counter subset is zero, said sequencing elements accepting a count in and rippling a count out to a next sequencing element.

2. A sequencer as recited in claim 1 wherein said sequencing element processes said counter proxy by performing any one of the processes of the group consisting of decrementing a count value by one, maintaining said count value, and resetting said count value to a reset counter value.

3. A sequencer as recited in claim 2 wherein said decrement process comprises a shift of the one hot counter proxy from a more significant bit to a less significant bit.

4. A sequencer as recited in claim 3 wherein a terminal count condition is determined by detecting a conjunctive combination of a logic one in a least significant bit of said one hot counter proxy and a decrement.

5. A sequencer as recited in claim 3 wherein said count out is rippled to said count in of said next sequencing element.

6. A sequencer as recited in claim 1 wherein a borrow out is rippled through said sequencing elements and further comprising counter clean-up logic that synchronizes said one hot representation with said high order counter subset based upon a value of said one hot representation and said borrow out at an end of said processing through all of said sequencing elements.

7. A sequencer as recited in claim 6 wherein said borrow out is determined by a logic 1 in a single location of said counter proxy.

8. A sequencer as recited in claim 7 wherein said borrow out is determined by bit7 of said one hot counter proxy.

9. A sequencer as recited in claim 1 wherein each said sequencing element selectively decrements said counter proxy.

10. A sequencer as recited in claim 9 wherein each said sequencing element selectively decrements based upon said subset of said de-multiplexed incoming data.

11. A sequencer as recited in claim 1 wherein said counter proxy is able to fully represent a decrement in each one of said sequencing elements.

12. A sequencer as recited in claim 11 wherein said lower order bit counter subset has at least as many bits as are able to digitally represent a number of said sequencing elements.

13. A sequencer as recited in claim 12 wherein there are eight sequencing elements and said one hot counter proxy comprises at least 16 bits.

14. A sequencer as recited in claim 1 and further comprising at least one counter reset value processed by said sequencing elements and said counter clean up logic.

15. A method for sequencing comprising the steps of:
Generating a counter proxy from a counter, said counter comprising a low order counter subset and a high order counter subset, said counter proxy comprising a one hot representation of said low order counter subset added to eight if said high order counter subset is at least one and said low order counter subset if said high order counter subset is zero,
Rippling said counter proxy through multiple sequencing elements, Restoring coherency of said counter from said counter proxy after said step of rippling, and
Repeating said steps of generating, rippling and restoring.

16. A method for sequencing as recited in claim 15 and further comprising the step of processing said counter proxy wherein each sequencing element performs any one of the processes of the group consisting of the steps of decrementing a count value by one, maintaining said count value, and resetting said count value to a reset counter value.

17. A method for sequencing as recited in claim 16 wherein said step of decrementing comprises a shift of the one hot counter proxy from a more significant bit to a less significant bit.

18. A method for sequencing as recited in claim 17 and further comprising the step of determining a terminal count condition by detecting a conjunctive combination of a logic one in a least significant bit of said one hot counter proxy and a decrement operation.

19. A method for sequencing as recited in claim 16 wherein said count out is rippled to said count in of said next sequencing element.

20. A method for sequencing as recited in claim 1 further comprising the step of rippling a borrow out through said sequencing elements

21. A method for sequencing as recited in claim 20 said step of restoring coherency further comprising synchronizing said one hot representation with said high order counter subset based upon a value of said one hot representation and said borrow out.

22. A method for sequencing as recited in claim 20 wherein said borrow out is determined by a logic 1 in a single location of said counter proxy.

23. A method for sequencing as recited in claim 22 wherein said borrow out is determined by bit7 of said one hot counter proxy.

24. A method for sequencing as recited in claim 15 wherein said step of rippling said counter proxy further comprises selectively decrementing said counter proxy within at least one of said sequencing elements.

25. A method of sequencing as recited in claim 24 wherein said step of selectively decrementing is based upon said subset of said de-multiplexed incoming data.

26. A method of sequencing as recited in claim 15 wherein said counter proxy fully represents a decrement in each one of said sequencing elements and a borrow on said high order counter subset.

27. A method for sequencing as recited in claim 26 said step of generating further comprises digitally representing said lower order bit counter subset with at least as many bits as are able to digitally represent a number of said sequencing elements.

28. A method of sequencing as recited in claim 26 wherein there are eight sequencing elements and said one hot counter proxy comprises at least 16 bits.

29. A method of sequencing as recited in claim 15 said step of rippling further comprising assigning a counter reset value to said counter proxy upon a reset condition.

30. A method for sequencing as recited in claim 15 and further comprising the steps of accepting incoming data, de-multiplexing said incoming data to create resources, wherein said step of processing further comprises processing said resources.

31. A method for sequencing as recited in claim 30 wherein each said sequencing element processes a subset of said resources.
